(19) United States
(12) Patent Application Publication
(10) Pub. No.: US 2024/0185885 A1
(43) Pub. Date: Jun. 6, 2024

(54) METHOD OF FORMING PATTERNED MAGNETIC MEDIA

(71) Applicant: Seagate Technology LLC, Fremont, CA (US)

(72) Inventors: Shuaigang Xiao, San Ramon, CA (US); Thomas Chang, Singapore (SG); Kim Yang Lee, Fremont, CA (US); XiaoMin Yang, Livermore, CA (US); Jiansheng Wu, San Jose, CA (US)

(73) Assignee: Seagate Technology LLC, Fremont, CA (US)

(21) Appl. No.: 18/516,140

(22) Filed: Nov. 21, 2023

Related U.S. Application Data
(60) Provisional application No. 63/386,255, filed on Dec. 6, 2022.

(51) Int. Cl. G11B 5/66; G11B 5/82; G11B 5/855

(52) U.S. Cl. CPC G11B 5/66; G11B 5/82; G11B 5/855

(57) ABSTRACT

A method of forming patterned magnetic media disclosed herein includes patterning a guiding layer on a substrate to form a nucleation guiding pattern. A layer of magnetic material is formed over the nucleation guiding pattern. The magnetic material may comprise a non-magnetic segregant. Magnetic grains are grown in a down-track direction and in a cross-track direction responsive to the nucleation guiding pattern and the non-magnetic segregant forms grain boundaries between the magnetic grains.

This application claims priority to U.S. Provisional Patent Application Ser. No. 63/386,255 entitled “METHOD OF FORMING PATTERNED MAGNETIC MEDIA” and filed Dec. 6, 2022, the entire contents of which are hereby incorporated by reference.

### BACKGROUND

Areal recording densities of magnetic storage devices are believed to be capped by the superparamagnetic limit, which refers to an areal density limit at which thermal fluctuations in the media spontaneously switch the polarization of recorded bits within a relatively short time, causing data loss. The areal density of the superparamagnetic limit depends upon both the media grain size and magnetic anisotropy. It is thought that the superparamagnetic limit may be deferred by increasing media anisotropy or by increasing effective grain volume. While increasing anisotropy can be achieved using a relatively large switching field (e.g., via techniques such as heat-assisted magnetic recording), increasing effective grain volume is believed to require either thicker media or increased physical grain alignment via patterning of the media, also known as “bit patterned media” (BPM).

In bit patterned media (BPM) devices, magnetic material on a disc is patterned into small, isolated islands or “grains” such that there is a single magnetic domain in each island or “grain.” The single magnetic domains can be a single grain or a plurality of strongly coupled grains that switch magnetic states in concert as a single magnetic volume. This is in contrast to continuous media wherein a single “bit” may have multiple magnetic domains separated by domain walls.

Fabrication methods for BPM can be challenging. Fabrication methods try to carefully control the particle size; particle separation; particle position; particle crystallographic, magnetic, and microstructural properties; interparticle interactions; etc., to provide effective BPM. Many patterning procedures comprise depositing the magnetic material onto appropriate seed layers, often by sputter deposition, to produce a blanket thin film of a predetermined structure and composition. The material is then patterned into the predetermined pillar structure (e.g., dots, islands) removing magnetic material in regions between the predetermined pillar locations (e.g., trenches) down to the seed layer leaving behind magnetically and thermally isolated islands. Such removal is generally performed by an etching process through a mask to selectively remove material in predetermined locations. The selectivity of the etching process may not be perfect. Thus, the sensitive magnetic properties of the recording islands may be damaged by stray ion implantation at the pillar edges as well as through the mask. Ordered L10 FePt magnetic films (e.g., L10 FePt magnetic films) that are exposed to this etch damage are especially problematic because the atomically ordered layers that provide the desired magnetic properties are susceptible to ion damage.

### SUMMARY

The present disclosure describes a method of manufacturing 2D ordered magnetic islands, the two dimensions in the cross-track and in the down-track directions. A method of formation of a 2D nucleation guiding pattern that provides the guided growth of magnetic islands in a 2D ordered arrangement is described. Following the formation of the nucleation guiding pattern, a magnetic material is deposited and magnetic grains, separated by a segregant, grow on the nucleation guiding pattern as well as in between the nucleation guiding pattern. The magnetic grains are aligned on the nucleation guiding pattern due to the strong metal-to-metal bonding between the nucleation guiding pattern and the magnetic material. The ordering of the grains on the nucleation guiding pattern may propagate to adjacent grains such that short-range order of magnetic grains can be achieved, in two dimensions. A benefit of 2D ordered media is that one island per bit can be encoded.

In one example, a method of forming patterned magnetic media is described. The method comprises the steps of: patterning a guiding layer on a substrate to form a nucleation guiding pattern; forming a layer of magnetic material over the nucleation guiding pattern, wherein the magnetic material comprises a non-magnetic segregant; and growing magnetic grains in a down-track and in a cross-track direction responsive to the nucleation guiding pattern, wherein the non-magnetic segregant forms grain boundaries between the magnetic grains.

In another example, a system comprising a patterned magnetic media including magnetic grains substantially aligned in a down-track and magnetic grains substantially aligned in a cross-track direction is described. The magnetic grains are formed responsive to a nucleation guiding pattern. The system further includes an actuator assembly comprising a writer and a controller configured to control the writer to write an individual data bit by generating magnetic transitions in the magnetic grains of the patterned media.

### BRIEF DESCRIPTION OF THE DRAWINGS

FIGS. 1A and 1B illustrate an example data storage device that includes a patterned media with magnetic grains that are aligned in two directions (2D), according to various aspects of the present disclosure.

FIG. 2 illustrates an example magnetic grain arrangement for grain-patterned media, according to various aspects of the present disclosure.

FIG. 3 is a flow chart illustrating an example method of manufacturing grain patterned media, according to various aspects of the present disclosure.

FIG. 4 is an example cross-sectional view of a grain patterned media, according to various aspects of the present disclosure.

FIGS. 5A-5D illustrate example nucleation guiding patterns, according to various aspects of the present disclosure.

### DETAILED DESCRIPTION

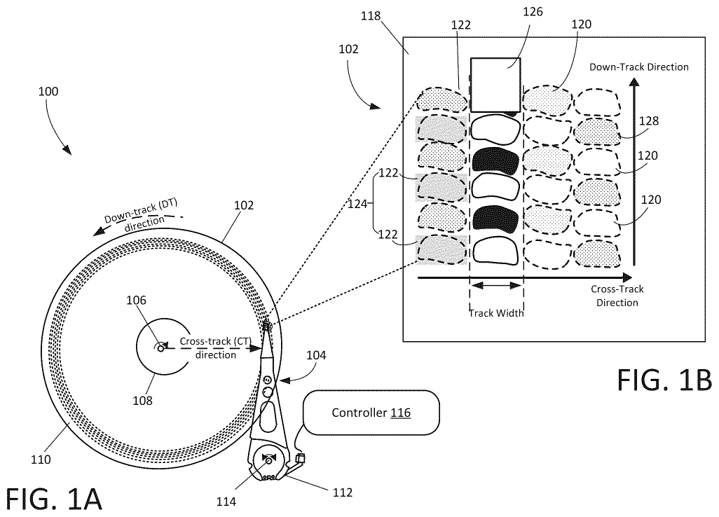

FIGS. 1A and 1B illustrate an example data storage device that includes a patterned media with magnetic grains that are aligned in two directions (2D), according to various aspects of the present disclosure.

Data storage device 100 includes patterned media 102, controller 116 and transducer head assembly 104. Patterned media 102 includes at least one magnetic storage disc on which data bits can be recorded using writer 126 on transducer head assembly 104 and from which data bits can be read using a magnetoresistive element on the transducer head assembly 104. As illustrated in FIG. 1A, the patterned media 102 rotates about a spindle center or a disc axis of rotation 106 and includes an inner diameter 108 and an outer diameter 110 between which are a number of concentric data tracks.

Transducer head assembly 104 includes actuator assembly 112 and writer 126. Transducer head assembly 104 is mounted on actuator assembly 112 at an end distal to an actuator axis of rotation 114. Transducer head assembly 104 flies in close proximity above the surface of patterned media 102 during disc rotation. Actuator assembly 112 rotates during a seek operation about the actuator axis of rotation 114. The seek operation positions transducer head assembly 104 over a target data track for read and write operations.

In the example of FIGS. 1A and 1B, controller 116 of data storage device 100 is configured to control writer 126 to generate the magnetic transitions in the magnetic material of patterned media 102 to store data. Controller 116 of FIG. 1A may include software stored on a tangible computer-readable storage medium. As used herein, the term “tangible computer-readable storage media” excludes transitory propagating signals (e.g., carrier waves) but includes physically-manufactured media (memory devices) including without limitation RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by mobile device or computer.

As shown in FIG. 1B, patterned media 102 includes substrate 118 and magnetic islands or grains (e.g., grains 120) formed on patterned media 102 at fixed locations separated from one another by a non-magnetic material. An example of a non-magnetic material is a segregant (e.g., Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or a combination thereof). Grains 120 are aligned or substantially aligned in rows extending in the cross-track (radial) direction and aligned or substantially aligned along individual columns extending in the down-track direction (also referred to as the recording direction). Described another way, FIG. 1B illustrates a 2-dimensional ordered array of grains. Each grain (e.g., grain 120) includes a single magnetic domain which may be comprised of a single magnetic grain, or a few strongly coupled grains that switch magnetic states together as a single magnetic volume.

Magnetic grains 120 may be formed by any of a number of different processes. Example processes include subtractive processes (e.g., processes that create the magnetic islands by milling or etching into a magnetic layer and then backfilling with non-magnetic material) or by one or more additive processes (e.g., processes that create the magnetic islands by causing magnetic grains to nucleate at growth sites on a guiding layer). Depending on the methodology utilized to create magnetic grains 120, nucleation guiding pattern 124 may be arranged according to a select pattern or, instead, nucleation guiding pattern 124 may be randomly placed.

According to one implementation, this cross-track and down-track alignment is the result of a media manufacturing process that makes use of a nucleation guiding pattern which can limit the size and position of each one of the magnetic grains (e.g., grains 120) in the down-track and cross-track directions. In the example of FIG. 1B, nucleation guiding pattern 124 comprises a plurality of dots (e.g., guiding dots 122) and can be formed by patterning a guiding layer on substrate 118. In some examples, an interlayer (e.g. MgO) may be formed on a top surface of substrate 118 prior to formation of nucleation guiding pattern 124. Nucleation guiding pattern 124 may include one or more layers of a magnetic material, such as FePt, or FePtX, where X is a non-magnetic segregant. Examples of segregant X include Cr₂N, Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or any combination thereof. In some examples, nucleation guiding pattern 124 comprises a pure metal such as Pt or Ru. In other scenarios, nucleation guiding pattern 124 may comprise a non-magnetic material, for example PtMn, or other similar material.

A layer of magnetic material may be deposited over the nucleation guiding pattern 124 and magnetic material may form on top of nucleation guiding pattern 124. In some examples, a single magnetic grain 120 may form on top of guiding dot 122. In some examples, the ordering defined by nucleation guiding pattern 124 may propagate into adjacent magnetic grains 128. In other examples, and dependent upon the geometry and size of the nucleation guiding pattern, multiple grains 120 may form on top of each guiding dot 122.

In FIG. 1B, following deposition of a layer of magnetic material, responsive to nucleation guiding pattern 124, the magnetic material forms magnetic grains 120 in a down-track and in a cross-track direction. Magnetic grains 120 may be formed from a magnetic material such as FePtX, where X is a segregant. In some examples, segregant X may form grain boundaries between adjacent magnetic grains 120 and 128. In some examples, segregant X is a non-magnetic material (e.g., Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or a combination thereof) and has a concentration of up to about 60% by volume.

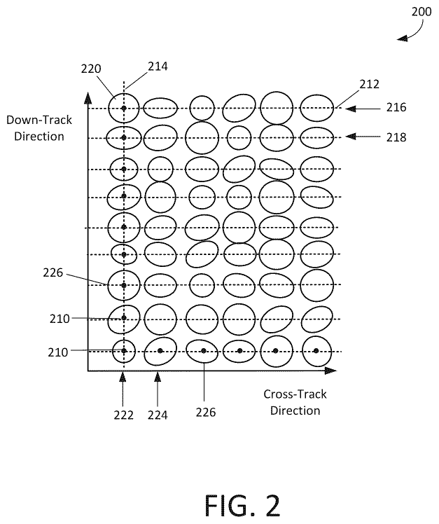

FIG. 2 illustrates an example of magnetic grain arrangement for grain-patterned media, according to various aspects of the present disclosure. Magnetic grain arrangement 200 in FIG. 2 includes single magnetic grains 220 that may be arranged (e.g., grown) on a storage medium (e.g., patterned media 102 of FIG. 1) at fixed locations. In some examples, the magnetic grains are separated from one another by a non-magnetic segregant material such as a dielectric material. Examples of a non-magnetic segregant material include Cr₂N, Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or a combination thereof.

FIG. 2 includes cross-track (or radial) axis 212 and down-track (or recording) axis 214. In the example of FIG. 2, magnetic grains 220 are substantially aligned along cross-track axis 212 and down-track axis 214. Cross-track axis 212 can be drawn to substantially intersect all of the grain centers 210 along a common row in the cross-track direction. Down-track axis 214 can be drawn to substantially intersect all of the grain centers 210 of grains 220 along a common column in the down-track direction.

In contrast to the example described in FIG. 2, where grain centers 210 of grains 220 substantially align with one another along cross-track axis 212 and down-track axis 214, in some examples, edges 226 of grains 220 may instead align with one another along cross-track axis 212 and down-track axis 214.

According to one implementation, this cross-track and down-track direction alignment within individual rows and columns of grains is the result of a media manufacturing process that makes use of a nucleation guiding pattern (e.g., cross-track nucleation guiding patterns 216 and 218 and down-track nucleation guiding patterns 222 and 224) to limit the size and position of each one of the magnetic grains in the cross-track and the down-track directions. In one example, each of magnetic grains 220 in magnetic grain arrangement 200 has a diameter of about 15 nm or less and a center that is within about +/−2 nm or less of alignment with cross-track axis 212 and within about +/−2 nm or less of alignment with down-track axis 214.

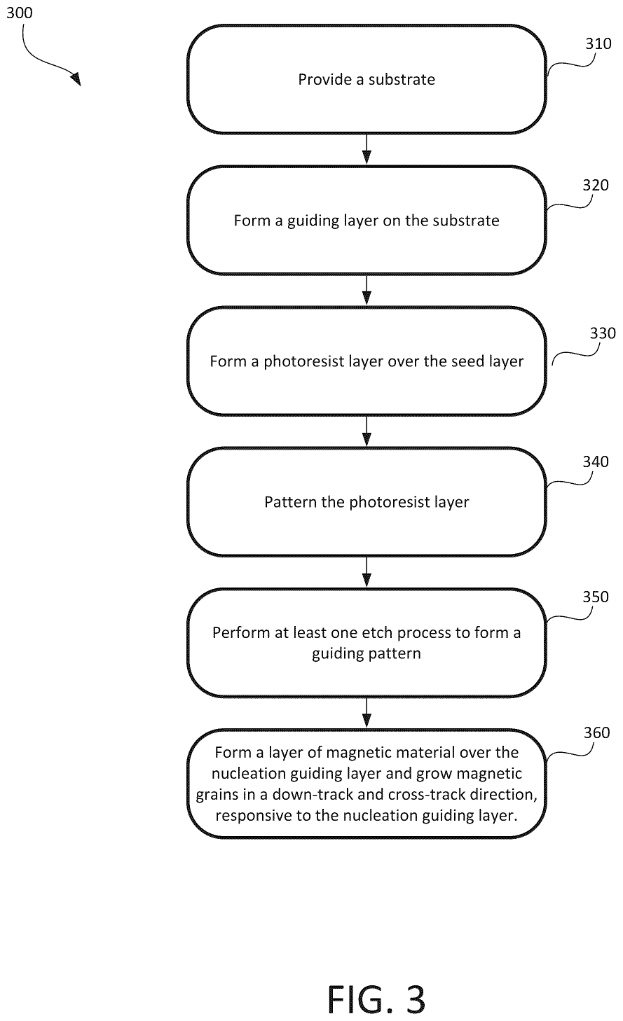

FIG. 3 is a flow chart illustrating an example method of manufacturing grain patterned media, according to various aspects of the present disclosure. Flowchart 300 of FIG. 3 is described with reference to FIG. 1 and FIG. 2. Substrate 118 is provided at step 310. Substrate 118 may be formed of glass, aluminum, silicon, titanium, titanium carbide, quartz or other suitable materials. Substrate 118 may be subjected to processing such as cutting, polishing or chemical treatment. In some examples, an interlayer is formed on a top surface of substrate 118, prior to any further processing steps.

A guiding layer is formed on top of substrate 118 at step 320. In the example where an interlayer is formed on a top surface of substrate 118, guiding layer is formed on top of the interlayer. The guiding layer may include one or more layers of a magnetic material such as FePt or FePtX, where X is a segregant material or may be formed from a non-magnetic material (for example, PtMn or others). Examples of segregant material include Cr₂N, Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or a combination thereof. In some cases, segregant X has a concentration of no more than about 50% by volume of the guiding layer. In other examples, segregant X may be as high as about 60% by volume. In some examples, guiding layer may be a pure metal such as Pt or Ru. The guiding layer is deposited with known physical or chemical deposition techniques such as radio frequency (RF) sputtering, direct current (DC) sputtering, reactive magnetron sputtering, chemical vapor deposition (CVD), pulsed laser deposition, molecular beam epitaxy and atomic layer deposition (ALD). The thickness of the guiding layer may range from about 0.25 nm to about 5.0 nm and beyond

In step 330, a photoresist layer is formed over the guiding layer. The photoresist in photoresist layer can include any photoresist used in modern lithography methods. The purpose of the photoresist layer is to mask or protect regions during etch process steps which will remove material that is left unprotected.

In step 340, photoresist layer is patterned to form photoresist features in photoresist layer. Photoresist features may be formed by a variety of known techniques. In some examples, photoresist features may be formed using a lithography technique. Examples of lithography techniques include optical lithography, such as deep ultraviolet (DUV) lithography, which uses light to transfer a pattern from a photomask to light-sensitive photoresist. Other examples of lithography include nanoimprint lithography (NIL), block copolymer lithography, immersion lithography and e-beam lithography.

In step 350, at least one etch process is performed. During the at least one etch process, any portion of guiding layer not covered by photoresist features is removed and a nucleation guiding pattern formed in the guiding layer (e.g., nucleation guiding pattern 124 of FIG. 1). Nucleation guiding pattern 124 may include guiding dots 122. Any method of etching known to and commonly used by those of ordinary skill in the art may be utilized. Examples of etch methods include reactive ion etching (RIE), sputter etching, wet etching, ion-beam etching, plasma etching or inductively coupled plasma (ICP) etching. In some examples, step 350 may be a selective etch process.

Following the at least one etch process, the nucleation guiding pattern will include etched and unetched regions. The unetched regions may protrude and the etched regions may be recessed. For example, if a checkerboard pattern is etched into the guiding layer, after the etch process there would be alternating etched (recessed) and unetched (protruding) regions.

A layer of magnetic material is formed over the nucleation guiding pattern (e.g., nucleation guiding pattern 124 of FIG. 1) in step 360. During formation of the layer of magnetic material, individual magnetic grains (e.g., grains 220 of FIG. 2) of the magnetic material may be attracted to nucleation guiding pattern 124 due to strong metal-to-metal bonding strength. The size of magnetic grain 220 is controlled by the dimensions of nucleation guiding pattern 124 and in particular, guiding dots 122. In some examples a single magnetic grain may nucleate over unetched region which includes guiding dot 122. In other examples multiple magnetic grains may nucleate over guiding dot 122.

The magnetic material may include one or more layers of a magnetic material such as FePt or FePtX, where X is a segregant material. Examples of segregant material include Cr₂N, Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or a combination thereof. In some cases, segregant X has a concentration of no more than 50% by volume of the guiding layer. In other examples, segregant X may be as high as 60% by volume. The magnetic material is deposited with known physical or chemical deposition techniques such as radio frequency (RF) sputtering, direct current (DC) sputtering, reactive magnetron sputtering, chemical vapor deposition (CVD), pulsed laser deposition, molecular beam epitaxy and atomic layer deposition (ALD).

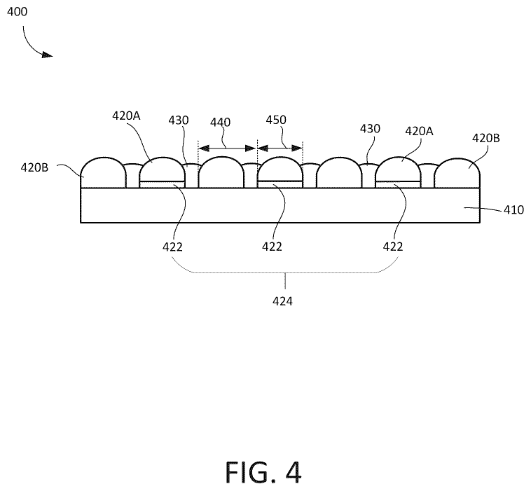

FIG. 4 is an example cross-sectional view of a grain patterned media, according to various aspects of the present disclosure. Grain patterned media 400 includes substrate 410, magnetic grains 420A and 420B (collectively, magnetic grains 420), segregant 430, guiding dots 422, nucleation guiding pattern 424, etched region 440 and unetched region 450. According to one example, grain patterned media 400 has features the same as or similar to those formed in the example method of manufacturing grain patterned media, described by the flow chart in FIG. 3.

In the example of FIG. 4, a guiding layer is formed on substrate 410 and at least one etch process (e.g., the at least one etch process in step 350 of FIG. 3) is employed to remove portions of the guiding layer to form nucleation guiding pattern 424. Nucleation guiding pattern 424 comprises a plurality of guiding dots 422. Following the at least one etch process, nucleation guiding pattern 424 includes etched regions 440 and unetched regions 450. Prior to formation of magnetic grains 420A on nucleation guiding pattern 424, unetched regions 450 may protrude and include guiding dots 422 and etched regions 440 may be recessed.

When a layer of magnetic material is formed over the unetched regions 450 and etched regions 440 of nucleation guiding pattern 424, magnetic grains 420A nucleate preferentially in unetched regions 450 (e.g., on top of guiding dots 422) due to strong metal-to-metal bonding strength between magnetic grains 420A and guiding dots 422. In some examples, the ordering defined by nucleation guiding pattern 424 may propagate into adjacent magnetic grains 420B in etched regions 440. In the example where the ordering propagates into adjacent magnetic grains 420B, density multiplication and long-range order of magnetic grains 420 may be achieved. In the example of FIG. 4, segregant 430 forms grain boundaries between magnetic grains 420.

In some examples and dependent upon the size of guiding dots 422, a plurality of magnetic grains 420A may nucleate on top of each guiding dot 422. In other examples, a single magnetic grain 420A may form on top of each guiding dot 422. In the example where a single magnetic grain 420A forms on top of each guiding dot 422, each single grain 420A may switch independently from neighboring grains 420 and may correspond to a single bit of patterned media (e.g., one bit per grain i. The growth of magnetic grains 420 may be controlled during the magnetic layer formation process by way of target composition, deposition temperature, pressure etc. The size of magnetic grains 420 may be controlled by the percentage of segregant 430 in nucleation guiding pattern 424 and/or by the thickness of nucleation guiding pattern 424.

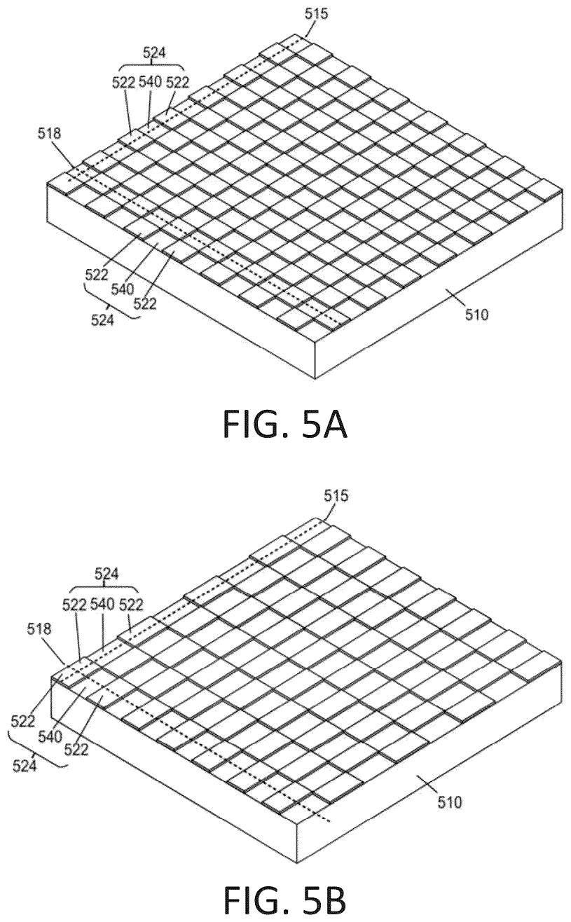

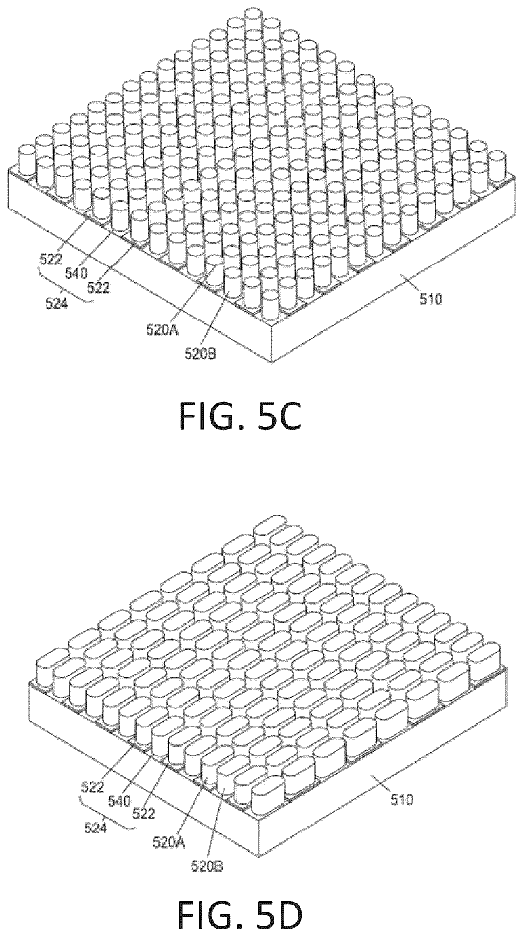

FIGS. 5A and 5B illustrate example perspective views of nucleation guiding patterns on substrate, according to various aspects of the present disclosure. FIGS. 5C and 5D illustrate example perspective views of magnetic grains formed on nucleation guiding patterns, respectively, according to various aspects of the present disclosure.

FIG. 5A illustrates an example perspective view of a nucleation guiding pattern 524 formed on substrate 510. Nucleation guiding pattern 524 includes guiding dots 522 and etched regions 540. In the example of FIG. 5A, a matrix of islands of guiding dots 522 is formed in an array with rows 515 and columns 518. In any given row 515 or column 518, nucleation guiding pattern 524 comprises an alternating pattern of guiding dots 522 and etched regions 540. In other words, in adjacent rows and columns, etched region 540 is adjacent to guiding dot 522 and guiding dot 522 is adjacent to etched region 540. Said another way, in the example of FIG. 5A, nucleation guiding pattern 524 is formed in a checkerboard pattern. Guiding dots 522 remain in unetched regions (e.g., unetched regions 450 of FIG. 4) of guiding layer following at least one etch process step (e.g., etch process step 350 of FIG. 3). In some examples and in the example of FIG. 5A, guiding dots 522 are square in shape with dimensions of about 12 nm by about 12 nm or less. In the example of FIG. 5B, guiding dots 522 dots are rectangular in shape with dimensions of about 10 nm by about 15 nm or less. In the example of FIGS. 5A and 5B, nucleation guiding pattern 524 includes guiding dots 522 that are square or rectangular in shape. It should be noted that nucleation guiding pattern 524 and guiding dots 522 may be formed in any size, shape or aspect ratio.

FIGS. 5C and 5D illustrate example perspective views of magnetic grains formed on nucleation guiding patterns, according to various aspects of the present disclosure. FIG. 5C includes substrate 510, nucleation guiding pattern 524 and magnetic grains 520A and 520B (collectively, magnetic grains 520). Nucleation guiding pattern 524 includes guiding dots 522 and etched regions 540. In the example of FIGS. 5C and 5D, when a layer of magnetic material is formed over guiding dots 522 and etched regions 540 of nucleation guiding pattern 524, magnetic grains 520A nucleate preferentially in unetched regions 540 (e.g., on top of guiding dots 522) due to strong metal-to-metal bonding strength between magnetic grains 520A and guiding dots 522. In some examples, the ordering defined by nucleation guiding pattern 524 may propagate into adjacent magnetic grains 520B in etched regions 540. Preferably, every guiding dot 522 of nucleation guiding pattern 524 initiates growth of a single grain 520 of magnetic material with well-defined dimensions corresponding to the dimensions of each guiding dot 522. In the example where the ordering propagates into adjacent magnetic grains 520B, density multiplication and short-range order of magnetic grains 520 may be achieved. In some examples and dependent upon the size of guiding dots 522, a plurality of magnetic grains 520A may nucleate on top of each guiding dot 522. In other examples, a single magnetic grain 520A may form on top of each guiding dot 522. In some examples, magnetic grains have a diameter ranging from about 6 nm to about 15 nm. Grain size and grain size distribution of magnetic grains 520 may be controlled by the size of guiding dot 522 with an approximate grain size sigma of about 10% to about 15%.

Various examples have been presented for the purpose of illustration and description. These and other examples are within the scope of the following claims.

What is claimed is:

1. A method of forming patterned magnetic media, the method comprising the steps of:
patterning a guiding layer on a substrate to form a nucleation guiding pattern;
forming a layer of magnetic material over the nucleation guiding pattern, wherein the magnetic material comprises a non-magnetic segregant; and
growing magnetic grains in a down-track direction and in a cross-track direction responsive to the nucleation guiding pattern, wherein the non-magnetic segregant forms grain boundaries between the magnetic grains.

2. The method of claim 1, wherein patterning the guiding layer comprises the steps of:
forming a guiding layer on the substrate;
forming a photoresist layer over the guiding layer;
patterning the photoresist layer; and
performing at least one etch process to form the nucleation guiding pattern.

3. The method of claim 1, wherein the magnetic grains in the down-track direction comprise grain centers in substantial alignment with one another or grain edges in substantial alignment with one another.

4. The method of claim 1, wherein the magnetic grains in the cross-track direction comprise grain centers in substantial alignment with one another or grain edges in substantial alignment with one another.

5. The method of claim 1, wherein forming a layer of magnetic material comprises forming a single magnetic grain over the nucleation guiding pattern.

6. The method of claim 5, wherein forming a single magnetic grain over the nucleation guiding pattern includes forming a single bit.

7. The method of claim 1, wherein forming a layer of magnetic material comprises forming a plurality of magnetic grains over the nucleation guiding pattern.

8. The method of claim 1, wherein the nucleation guiding pattern includes regions that are etched.

9. The method of claim 1, wherein the nucleation guiding pattern includes regions that are unetched.

10. The method of claim 9, wherein the unetched regions comprise a metal.

11. The method of claim 10, wherein a single magnetic grain is formed over the unetched region.

12. The method of claim 5, wherein the magnetic grains have a diameter ranging from about 6 nm to about 15 nm.

13. The method of claim 1, wherein patterning the guiding layer comprises forming a checkerboard pattern.

14. The method of claim 1, wherein the non-magnetic segregant comprises Cr₂N, Ci₃N₄, VN, NbN, TiN, TaN, HfN, B₂O₃, MoO₃, CuO, WO₃, ZnO, ZrO₂, SiO₂, WO₃, GeO₂, Nb₂O₅, Ta₂O₅, ZnO, CiOₓ, Cr₂O₃, SnO₂, C, BN, SiO₂, AlN, Ag or combinations thereof.

15. The method of claim 1, wherein the guiding layer comprises FePt, Ru, Pt or combinations thereof.

16. The method of claim 1, wherein the non-magnetic segregant has a concentration of up to about 60% by volume.

17. A system comprising:
a patterned magnetic media including magnetic grains substantially aligned in a down-track direction and magnetic grains substantially aligned in a cross-track direction wherein the magnetic grains are formed responsive to a nucleation guiding pattern;
an actuator assembly comprising a writer; and
a controller configured to control the writer to write an individual data bit by generating magnetic transitions in the magnetic grains of the patterned media.

18. The system of claim 17, wherein the magnetic grains have a diameter ranging from about 6 nm to about 15 nm.

19. The system of claim 17, wherein the magnetic grains substantially aligned in the down-track direction have either grain centers in substantial alignment with one another or grain edges in substantial alignment with one another.

20. The system of claim 17, wherein the magnetic grains substantially aligned in the cross-track direction have either grain centers in substantial alignment with one another or grain edges in substantial alignment with one another.
